(19) United States
(12) Patent Application Publication
(10) Pub. No.: US 2014/0319437 A1
(43) Pub. Date: Oct. 30, 2014

(54) JACK APPARATUS

(71) Applicant: ABL X-PRESS LTD., Edmonton (CA)

(72) Inventor: Allan Roy Plummer, Edmonton (CA)

(73) Assignee: ABL X-PRESS LTD., Edmonton (CA)

(21) Appl. No.: 14/262,564

(22) Filed: Apr. 25, 2014

Related U.S. Application Data
(60) Provisional application No. 61/816,050, filed on Apr. 25, 2013.

(51) Int. Cl. B66F 1/00

(52) U.S. Cl. CPC B66F 1/00
USPC 254/105

(57) ABSTRACT

There is provided a jack apparatus having a base plate with a top surface, a bottom surface and a peripheral edge, the top surface having an opening, a bar extending from the top surface of the base plate, and a travelling member mounted to the bar. The travelling member has an actuator that moves the travelling member along the bar relative to the base plate and a lifting bracket mounted at an end of the travelling member, the lifting bracket having a top surface and a bottom surface, and the lifting bracket being sized to fit within the opening when the travelling member is adjacent to the base plate such that the lifting bracket engages the base plate.

### FIELD

The present disclosure is related to the field of jack apparatuses, such as jack apparatuses for use in keeping doors open or lifting objects such as windows and door frames during installation, and the levelling of large appliances during installation thereof.

### BACKGROUND

In the moving and transport logistics industries, moving large items in and out of buildings and structures often requires doors to be propped open to allow unrestricted movement through the doorways. Often, doors have mechanisms to automatically close the door once a person passes through the doorway. One simple solution is to place a wedge underneath a door to keep the door in position although this is not suitable for all situations.

### SUMMARY

A jack apparatus is provided for use in holding a door open, the apparatus including a base and a lifting mechanism such as a bar clamp mechanism, operatively extending from the base. The apparatus further includes an L-shaped lifting bracket on the lifting mechanism. In operation, the base and lifting bracket are inserted underneath a door, and the lifting mechanism is operated to raise the lifting bracket to apply force to the door to hold it in position.

Broadly stated, in some embodiments, a jack apparatus is provided, comprising a lifting mechanism further comprising a bar having first and second ends, and a travelling member configured for movement along the bar, a lifting bracket operatively disposed on the travelling member, and a base disposed at the first end of the bar wherein the base is substantially perpendicular to the bar, the base further comprising an opening for receiving the bracket when the travelling member is positioned on the bar near the base.

Broadly stated, in some embodiments, the lifting mechanism may comprise a bar clamp.

Broadly stated, in some embodiments, the bar may comprise an I-beam.

Broadly stated, in some embodiments, the travelling member may comprise a ratcheting mechanism of a bar clamp.

Broadly stated, in some embodiments, the ratcheting mechanism may further comprise a thumb guard.

Broadly stated, in some embodiments, the jack apparatus may further comprise a door stop disposed on the second end of the bar.

Broadly stated, in some embodiments, the lifting bracket may comprise an L-shaped member comprising a vertical portion and a horizontal portion extending therefrom.

Broadly stated, in some embodiments, the horizontal portion may be configured to urge items placed thereon towards the vertical portion.

Broadly stated, in some embodiments, the horizontal portion may increase in thickness as it extends away from the vertical portion.

Broadly stated, in some embodiments, the horizontal portion may further comprise a non-skid coating disposed on a lifting surface thereof.

Broadly stated, in some embodiments, the base may further comprise at least one sloped side such that the base decreases in thickness between the opening and an edge of the base.

Broadly stated, in some embodiments, the base may further comprise a non-skid coating disposed on a bottom surface thereof.

According to an aspect, there is provided a jack apparatus having a base plate with a top surface, a bottom surface and a peripheral edge, the top surface having an opening, as well as a bar extending from the top surface of the base plate and a travelling member mounted to the bar, the travelling member having an actuator that moves the travelling member along the bar relative to the base plate and a lifting bracket mounted at an end of the travelling member, the lifting bracket having a top surface and a bottom surface, and the lifting bracket being sized to fit within the opening when the travelling member is adjacent to the base plate such that the lifting bracket engages the base plate.

According to another aspect, the lifting bracket may fit within the opening such that the top surface of the lifting bracket is at or below the top surface of the base plate.

According to another aspect, the bar may have a non-circular cross-section.

According to another aspect, the travelling member may have a ratcheting mechanism.

According to another aspect. the actuator may have a fixed handle and a lever extending out from the travelling member, and the lever may be biased away from the handle.

According to another aspect, the lever may have a thumb guard.

According to another aspect, the bar may have a door stop. The door stop may be mounted on an opposite end of the bar from the base plate.

According to another aspect, the lifting bracket is mounted below the travelling member.

According to another aspect, the based may be tapered toward at least a portion of the peripheral edge.

According to another aspect, the bar may have a releasable connection at a first end of the bar, by which the base plate may be connected. The bar may also have a releasable connection at a second end of the bar.

According to another aspect, the jack apparatus may have more than one bar connected end to end by releasable connections.

According to another aspect, the lifting bracket may be connected to the travelling member by an adjustable connection, and may connect the lifting bracket in more than one orientation.

According to another aspect the adjustable connection may be a sliding connection and may connect the lifting bracket in more than one lateral position along the travelling member.

According to an aspect, there is provided a jack and clamping apparatus having a base plate with a top surface, a bottom surface and a peripheral edge, the top surface having an opening and a connection point. The jack and clamping apparatus also have a bar with a first end and a second end, each end having a connection point capable of connecting to the connection point of the base plate such that the base plate supports the bar perpendicularly from the top surface of the base, and a travelling member mounted to the bar, the travelling member having a lever that moves the travelling member in toward the second end of the bar and a support bracket mounted at an end of the travelling member, the support bracket having a top surface and a bottom surface. The lifting bracket is sized to fit within the opening when the travelling member is positioned on the bar near the base plate, and an adjustable connection selectively connects the support bracket to the travelling connection in a first orientation and in a second orientation. The base plate and the travelling member are in a jacking configuration when the base plate is connected to the first end of the bar and the base plate and the travelling member is in a clamping configuration when the base plate is connected to the first end of the bar.

### BRIEF DESCRIPTION OF THE DRAWINGS

FIG. 1 is a front perspective view of a jack apparatus.

FIG. 2 is a rear perspective view of the jack apparatus.

FIG. 3 is a side elevation view of the jack apparatus of FIG. 1 in a raised position.

FIG. 4 is a side elevation view of the jack apparatus of FIG. 1 in a lowered position.

FIG. 5 is a rear elevation view of the jack apparatus of FIG. 1.

FIG. 6 is a perspective view of an alternative view of the jack apparatus.

FIG. 7 is a top plan view of the jack apparatus of FIG. 1.

FIG. 8 is a side elevation view in section of the jack apparatus of FIG. 1.

FIG. 9 is a perspective view of the jack apparatus holding a door.

FIG. 10 is a perspective view of the jack apparatus holding a gate.

FIG. 11 is a side elevation view of the jack apparatus in a clamping configuration.

FIG. 12 is a side elevation view of the jack apparatus in a further clamping position.

FIG. 13 is a side elevation view of the jack apparatus with multiple bars.

FIG. 14 is a side elevation view of two jack apparatuses connected together.

### DETAILED DESCRIPTION OF EMBODIMENTS

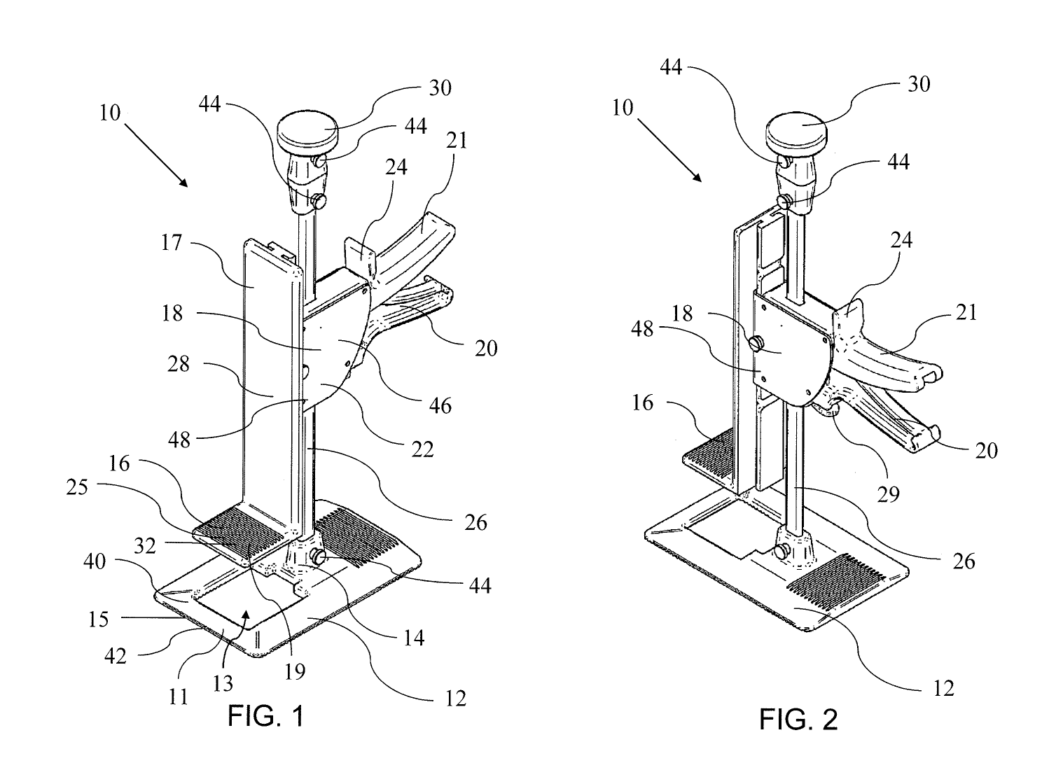

Referring to FIGS. 1 and 2, a jack apparatus 10 is shown. In the depicted embodiment, jack 10 has a base 12 shown as a base plate operatively coupled to a first end of bar 26 via a mounting block 14 on a top surface of base 12. Base 12 has a top surface 40 and a bottom surface 42. As shown, bar 26 extends perpendicularly from top surface 40 and bottom surface 42 is intended to engage a surface, such as a floor or ground surface or other surface that acts as a support for, jack 10. In some embodiments, base 12 may be comprised of a rigid material, such as 6061 aluminum, or such other functionally equivalent material as well known to those skilled in the art. Bar 26 may be attached to base 12 by fasteners or a releasable connection 44 formed in block 14 as shown, or bar 26 may be integrally formed with block 14 and base 12. Bar 26 may have a releasable connection 44 at one end only, or both ends of bar 26 as shown. Releasable connection 44 may be used to connect bar 26 to base 12 such that base 12 may be removed, and may also allow jack 10 to be used in different configurations, as will be discussed below. Accordingly, block 14 may also be either attached to or integrally formed with base 12. Preferably, the combination of base 12 and block 14 is operatively attached to bar 26 and configured to resist bar 26 moving or bending relative to base 12 and block 14 so as to prevent jack 10 from moving during use, which may result in jack 10 being disengaged from holding a door open or other load, as described in more detail below.

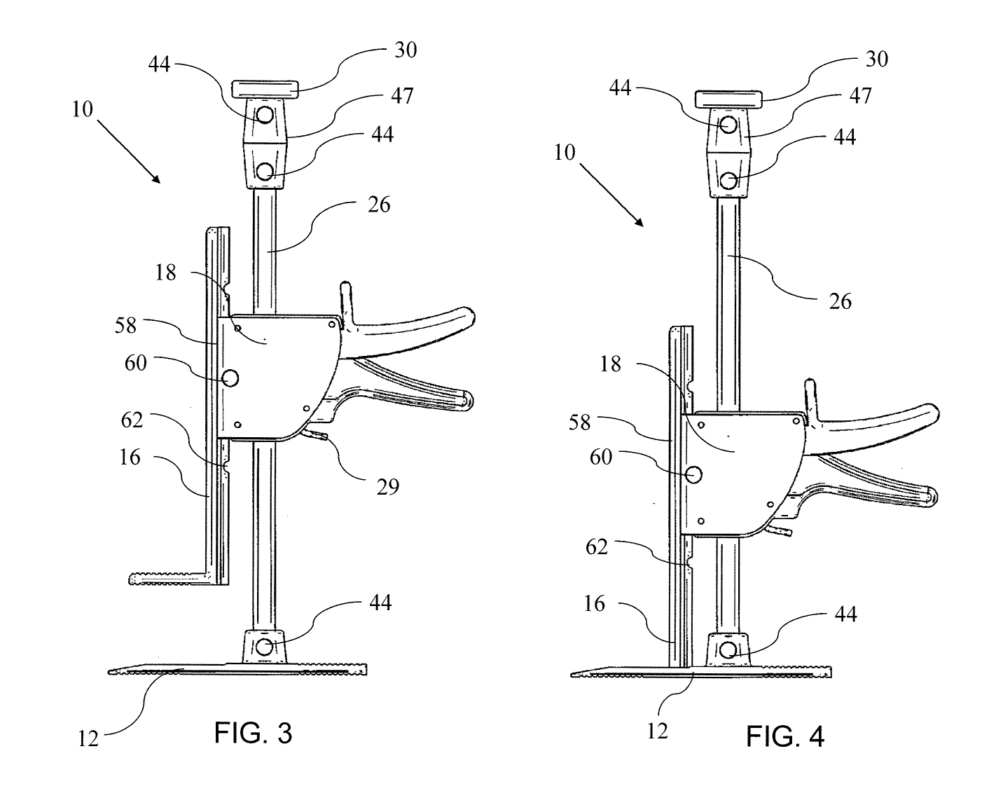

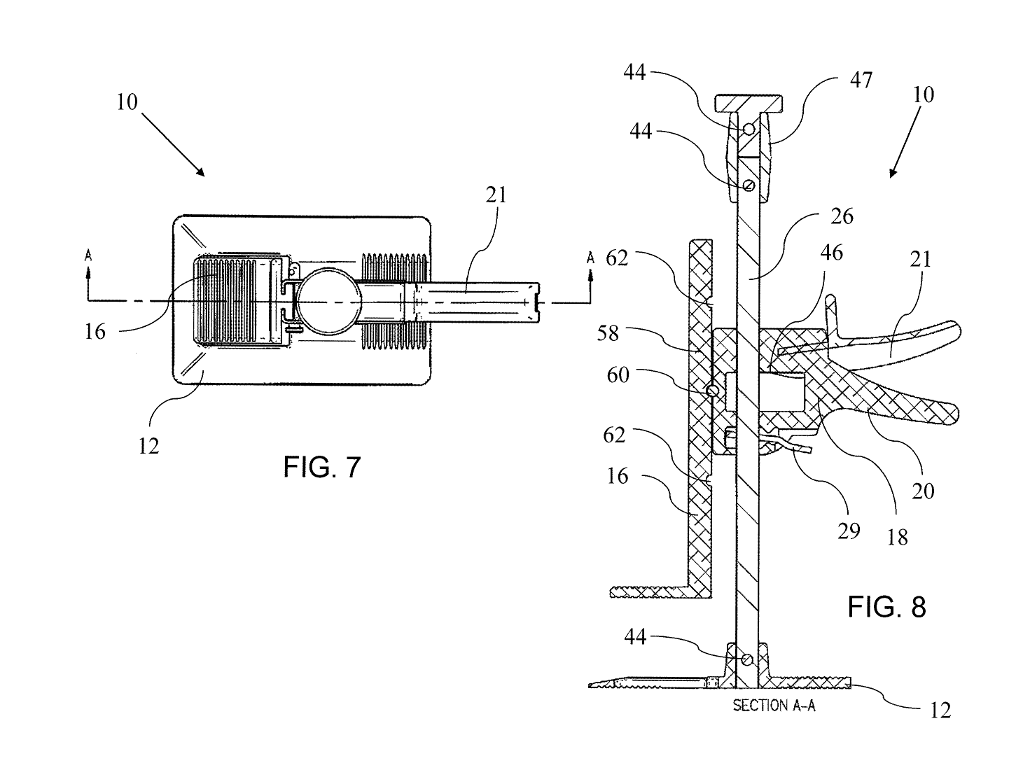

Jack 10 has a travelling member 18 disposed on bar 26. In the depicted embodiment, travelling member 18 has an actuator 22 that, when actuated, moves the travelling member along bar 26 relative to base 12. Referring to FIG. 3 and FIG. 4, the lifting bracket 16 may move between a raised position as seen in FIG. 3, and a lowered position as seen in FIG. 4, although the movement of lifting bracket 16 is not limited to these positions, as will be understood by those skilled in the art. In the depicted embodiments, travelling member 18 is similar to a ratcheting mechanism of a bar clamp, which is known to those skilled in the art. In a representative embodiment, travelling member 18 may comprise a 6 inch bar clamp wherein bar 26 may be approximately 12 inches in length. When configured as illustrated in the figures, jack 10 may be used to hold a door open, as described in more detail below, when the distance between the bottom of the door and the ground or floor below is up to approximately 8 inches. It is obvious to those skilled in the art that the length of bar 26 may be selected to any suitable length as required, and may be lengthened to hold doors in position where the distance between the door and the ground or floor is even greater. Referring to FIGS. 7 and 8, ratcheting mechanism 46 is shown. When force is applied to ratchet lever 21 it may be pressed against handle 20, causing a ratchet movement up bar 26.

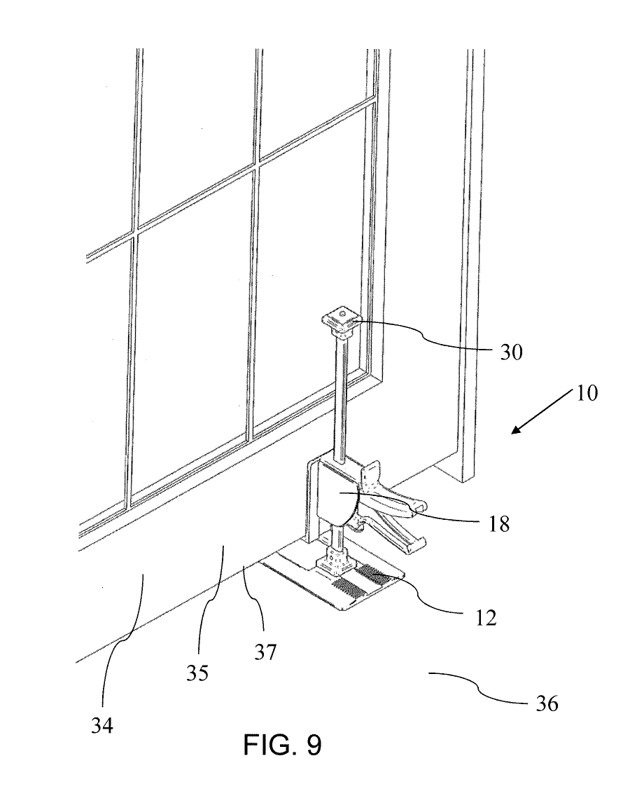

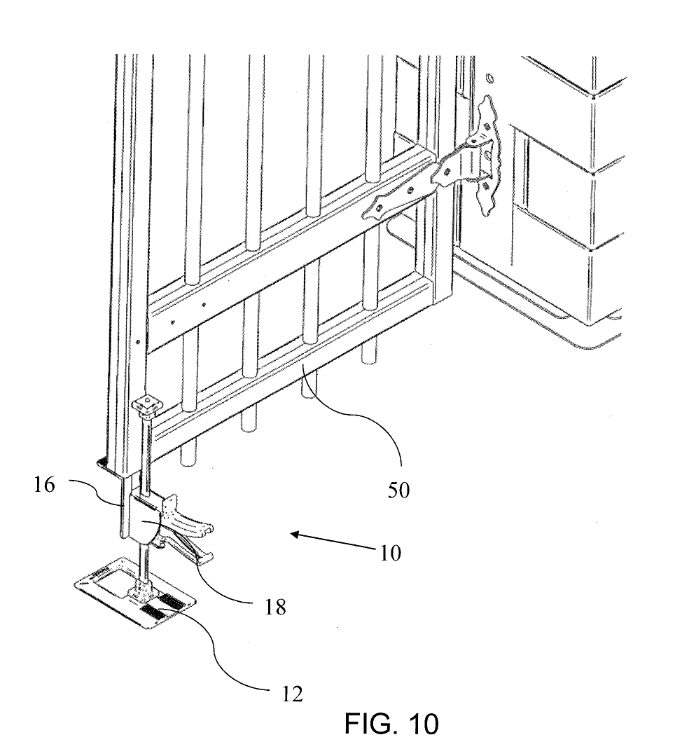

In some embodiments, travelling member 18 may comprise handle 20 and ratchet lever 21 that, when squeezed towards handle 20, may advance travelling member 18 along bar 26. In some embodiments, lever 21 may further comprise thumb guard 24 to prevent the mechanism from pinching the hand of a person operating jack 10. This is found necessary as ratcheting mechanism 46 is gripped in reverse from the normal operation of the ratcheting mechanism of a typical bar clamp. Preferably, bar 26 has a non-circular cross-section to resist twisting or swivelling of travelling member 18 about bar 26. In some embodiments, bar 26 may comprise a rectangular beam or an I-beam, as typically used in a bar clamp. Referring to FIG. 3, there may be a connection 58 between lifting bracket 16 and travelling member 18, or lifting bracket 16 may be integrally formed with travelling member 18. In some embodiments, lifting bracket 16 may be connected to the travelling member 18 using an adjustable connection 58. The adjustable connection 58 as shown is a sliding connection, although other types of connections will be apparent to those skilled in the art. In embodiments where adjustable connection 58 is a sliding connection, it may connect the lifting bracket 16 in more than one lateral position along the travelling member 18, where actuating a pin 60 releases lifting bracket 16 from travelling member 18 and permits it to be slid into a desired position and engage grooves 62. Alternatively, lifting bracket 16 may be slid enough to remove it from travelling member 18, and reintroduced in another orientation, as can be seen in FIGS. 9 and 10.

In some embodiments, jack 10 may comprise a lifting bracket 16 operatively attached or disposed at the bottom end 48 on travelling member 18. In the illustrated embodiment, bracket 16 may comprise an L-shaped member further comprising vertical portion 17 and horizontal portion 19 extending substantially perpendicular therefrom, as further illustrated in FIG. 3. Referring to FIGS. 1 and 2, in some embodiments, base 12 may comprise an opening 13 configured and sized to receive horizontal portion 19 of bracket 16 when travelling member 18 is adjacent to base 12 and lifting bracket 16 engages base 12, as shown in FIG. 4. Opening 13 may be within the outer perimeter of base 12, which improves the strength of base 12, or opening 13 may extend to the perimeter of base 12, as shown in FIG. 6. Bracket 16 may thus urge an item contacting the top lifting surface 25 of lifting bracket 16 away from base 12 when bracket 16 is being moved by travelling member 18. In some embodiments, lifting surface 25 may comprise non-skid coating 32, such as a non-skid deck coating as well known to those skilled in the art, disposed thereon. In some embodiments, bottom surface 42 of base 12 may also comprise non-skid coating 32 disposed thereon as bracket 16 may be designed to operate in either orientation, as described herein. The use of coating 32 may prevent jack 10 from moving or slipping when in operation.

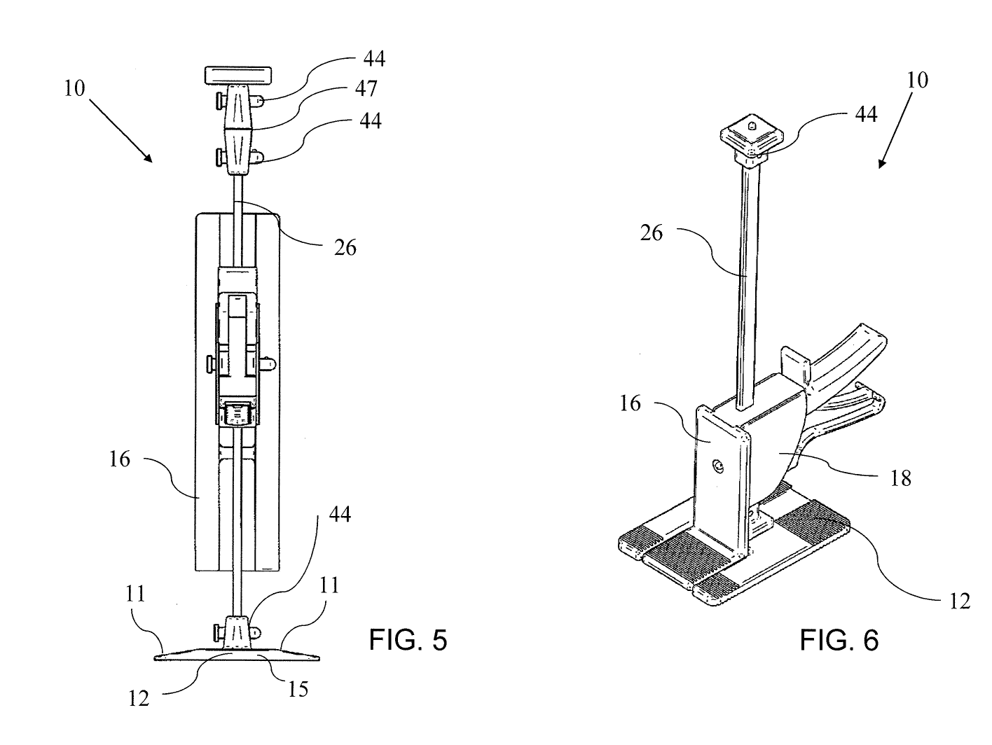

In some embodiments, base 12 may comprise a rectangular configuration, as shown in the illustrated embodiments. In a representative embodiment, base 12 may be approximately 4 inches square in dimension for a jack that is rated to 175 lbs. Generally speaking it has been found that, if base 12 is too large, the force will be more widely distributed and the amount of pressure and friction between base 12 and the support surface will be reduced. Accordingly, this reduces the amount of lateral force base 12 is able to withstand without sliding along the support surface. On the other hand, base 12 must be large enough to resist overbalancing as a result of a lateral force. It will be apparent to those skilled in the art that the size of base 12 may be adjusted, as is practical, based on the above principles and others, such as the load to be borne, the length of bar 26 and, when using jack 10 to hold open a door, the anticipated distance between a door and the ground or floor below as described in more detail below. In some embodiments, base 12 may have at least one sloped or chamfered side 11 extending from edge 15 towards opening 13 or any other side, as can be seen in FIG. 5. When configured this way, base 12 can be inserted underneath a door having minimal clearance above a floor and sometimes act as a door wedge when there is very little clearance.

Referring to FIG. 9, jack 10 is shown in operation in holding door 34 open. In FIG. 9, jack 10 may be placed on side 35 of door 34 with base 12 and horizontal portion 19 placed beneath door 34 in the gap between door 34 and floor 36 or other support surface. In some embodiments, jack 10 may comprise a door stop 30 disposed on a second end of bar 26 to act as a stop against door 34, and prevent jack 10 from marring the surface of door 34. Door stop 30 may also provide other functions, depending on the function jack 10 is being used for. Door stop 30 may be connected to the second end of the bar 26 with a releasable connection 44 similar to the releasable connection 44 at the first end of the bar 26 in a modular fashion. As shown, door stop 30 is connected to bar 26 by way of a female sleeve 47 that mates with connections 44 on both bar 26 and door stop 30. Sleeve 47 also allows additional bars 26 to be connected end to end, as will be discussed below. Using this design, jack 10 can be modular, such that various configurations can be achieved using only a few additional parts. It will be understood, however that other types of connections could also be used. Upon operating travelling member 18, bracket 16 is raised against the bottom edge of door 34 to apply force thereto, which results in door 34 being held in place. Operating release lever 29 releases jack 10 so it may slide freely along bar 26. The physical configuration of base 12, and the rigid attachment thereto of block 14 and bar 26 (as described above) allows jack 10 to operate like a cam such that any side to side movement of door 34 may cause base 12 to tile upward on one edge thus causing bracket 16 to rise up against door 34 and apply more force between the door and the support surface.

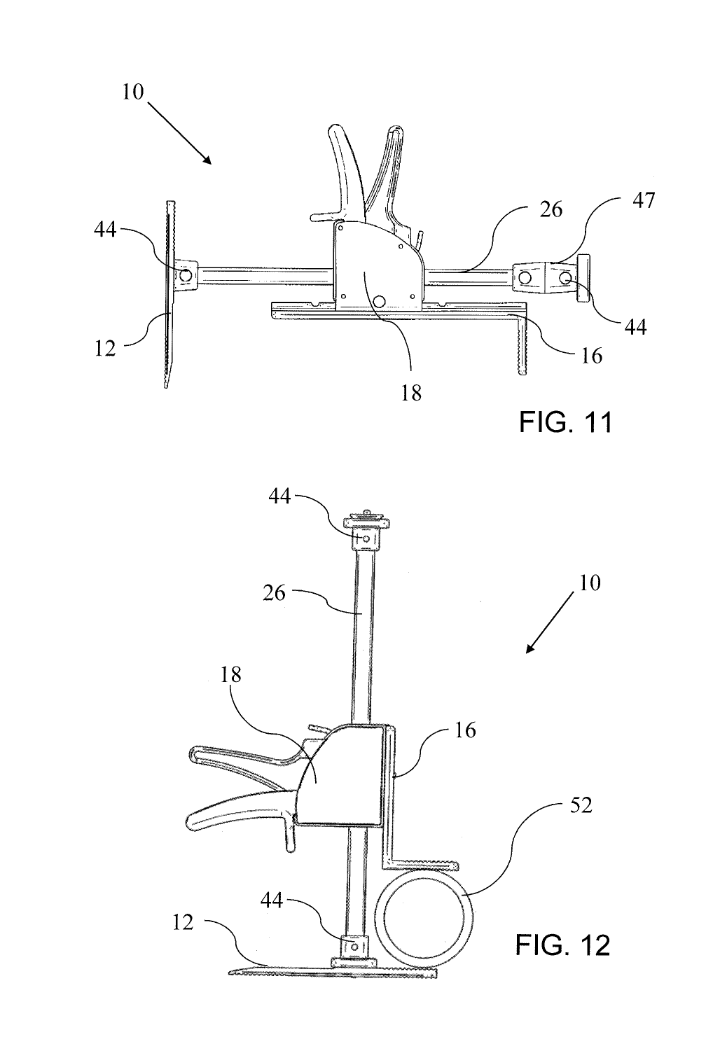

Referring to FIG. 10, jack 10 is shown in operation holding gate 50 in a stationary position. In the depicted embodiment, bracket 16 has been reversed from the orientation shown in FIG. 9 relative to base 12 and is being used to contact gate 50 should it be higher off the ground than would be accommodated by the configuration in FIG. 9. This may be accomplished using the adjustable connection 58 connecting the lifting bracket 16 to the travelling member 18, as the adjustable connection 58 may be configured to remove the lifting bracket 16 from the travelling member 18 by sliding it completely along the connection, and reattach bracket 16 in either orientation. It will be understood that other types of connections FIG. 11 also shows the jack 10 in this reverse orientation. Referring to FIG. 11, the ratcheting mechanism 46 can also be used in a reverse orientation, such that applying a force to the handle 20 and the ratchet lever 21 causes the travelling member 18 to move toward base 12. In the depicted embodiment, the reverse orientation has been achieved by attaching base 12 to the other end of bar 26.

In other applications, jack 10 may be used for centering a window in an opening (not shown) by placing at least one jack 10 between the window and the opening, the positioning of jack 10 selected by an installer so as to position the window that it is level and plumb within the opening before completing the installation of the window.

In other applications, jack 10 may be placed under a corner of a large appliance (not shown) to position it in a level position before adjusting a foot of the appliance to set its height.

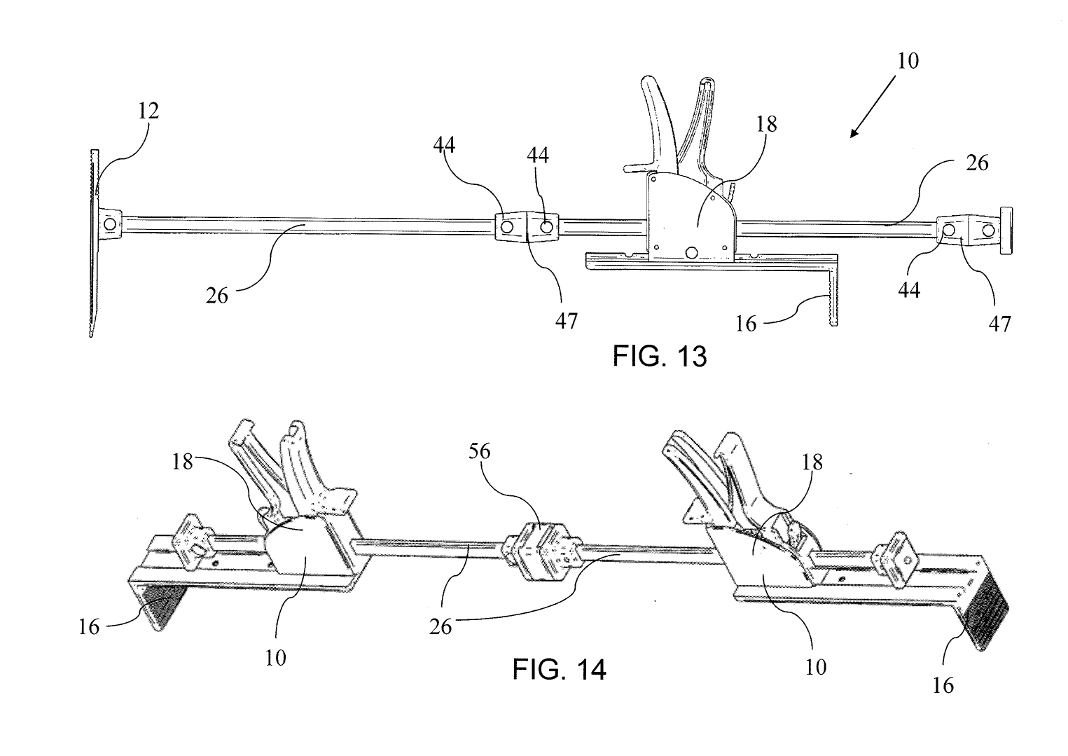

Referring to FIG. 12, jack 10 may also be used as a clamp for an object to be clamped 52. The object 52 can be placed between the top surface 40 of base 12 and the horizontal portion 19 of the lifting bracket 16. As in FIG. 11, the ratcheting mechanism 46 is oriented such that applying force to the handle 20 and the ratchet lever 21 will cause the bracket 16 to move towards the object 52, allowing a user to put pressure on object 52 such that it remains stationary. Referring to FIG. 13, a further clamping position is shown. In this embodiment jack 10 may have multiple bars 26 that are connected together end to end in a modular fashion. Bars 26 may be connected by a variety of methods, as will be understood by one skilled in the art, for example, by releasable connection 44 between the base 12 and the bar 26. Multiple bars 26 allow for larger objects to be clamped in jack 10 between base 12 and bracket 16, or for a higher lifting surface to be provided. Referring to FIG. 14, multiple jacks 10 may also be connected together in order to provide an adjustable clamp on either side of an object. In this embodiment, there is no base 12, and the combined jacks 10 have multiple brackets 16 to contact opposite sides of an object. As seen in FIG. 14, jacks 10 may also be joined by a joining block 56 instead of a sleeve 47, depending on the type of connection being used. Jacks 10 may also be reversed, such that they act as a spreader bar with travelling members 18 on either side.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the following claims should not be limited by the preferred embodiments set fourth in the examples above and in the drawings, but should be given the broadest interpretation consistent with the description as a whole.

1. A jack apparatus, comprising:
a base plate having a top surface, a bottom surface, and a peripheral edge, the top surface comprising an opening;
a bar extending from the top surface of the base plate; and
a travelling member mounted to the bar, the travelling member comprising:
an actuator that moves the travelling member along the bar relative to the base plate; and
a lifting bracket mounted at an end of the travelling member, the lifting bracket having a top surface and a bottom surface, the lifting bracket being sized to fit within the opening when the travelling member is adjacent to the base plate such that the lifting bracket engages the base plate.

2. The jack apparatus of claim 1, wherein the lifting bracket fits within the opening such that the top surface of the lifting bracket is at or below the top surface of the base plate.

3. The jack apparatus of claim 1, wherein the bar has a non-circular cross-section.

4. The jack apparatus of claim 1, wherein the travelling member comprises a ratcheting mechanism.

5. The jack apparatus of claim 1, wherein the actuator comprises a fixed handle and a lever extending out from the travelling member, the lever being biased away from the handle.

6. The jack apparatus of claim 5, wherein the lever comprises a thumb guard.

7. The jack apparatus of claim 1, the bar comprising a door stop mounted on an opposite end of the bar from the base plate.

8. The jack apparatus of claim 1, wherein the lifting bracket is mounted below the travelling member.

9. The jack apparatus of claim 1, wherein the base is tapered toward at least a portion of the peripheral edge.

10. The jack apparatus of claim 1, wherein the bar comprises a releasable connection at a first end of the bar.

11. The jack apparatus of claim 10, wherein the base plate is connected to the first end of the bar by the releasable connection.

12. The jack apparatus of claim 10, comprising a second releasable connection at a second end of the bar.

13. The jack apparatus of claim 12, comprising more than one bar connected end to end by the releasable connections.

14. The jack apparatus of claim 1, wherein the lifting bracket is connected to the travelling member by an adjustable connection.

15. The jack apparatus of claim 14, wherein the adjustable connection connects the lifting bracket to the travelling member in more than one orientation.

16. The jack apparatus of claim 14, wherein the adjustable connection is a sliding connection and connects the lifting bracket in more than one lateral position along the travelling member.

17. A jack and clamping apparatus, comprising:
a base plate having a top surface, a bottom surface, and a peripheral edge, the top surface comprising an opening and a connection point;
a bar having a first end and a second end, each end having a connection point capable of connecting to the connection point of the base plate such that the base plate supports the bar perpendicularly from the top surface of the base plate; and
a travelling member mounted to the bar, the travelling member comprising:
a lever that moves the travelling member in toward the second end of the bar;
a support bracket mounted at an end of the travelling member, the support bracket having a top surface and a bottom surface, the lifting bracket being sized to fit within the opening when the travelling member is positioned on the bar near the base plate; and
an adjustable connection that selectively connects the support bracket to the travelling connection in a first orientation and in a second orientation;
the base plate and the travelling member being in a jacking configuration when the base plate is connected to the first end of the bar and the base plate and the travelling member being in a clamping configuration when the base plate is connected to the first end of the bar.
